(19) United States
(12) Patent Application Publication
(10) Pub. No.: US 2005/0066159 A1
(43) Pub. Date: Mar. 24, 2005

(54) Remote IPSec security association management

(75) Inventors: Sakari Poussa, Espoo (FI); Mikael Latvala, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 10/720,054

(22) Filed: Nov. 25, 2003

(30) Foreign Application Priority Data
Sep. 22, 2003 (FI) 20031361

(51) Int. Cl. H04L 9/00

(52) U.S. Cl. 713/151

(57) ABSTRACT

The present invention concerns a method and a system for remotely and transparently managing security associations of Internet Protocol Security. The system comprises one or more application devices, each of which comprises at least one management client for issuing security association management requests. The system further comprises a service device comprising an Internet Protocol Security service means for providing one or more Internet Protocol Security services, and a management server for receiving the issued requests and for responding, in connection with the Internet Protocol Security service means, to the received requests. The system further comprises a communication network for securely connecting the application devices to the service device.

### BACKGROUND OF THE INVENTION

1. Field of the Invention

The invention relates to communications technology. In particular, the invention relates to a novel and improved method and system for remotely and transparently managing security associations of Internet Protocol Security.

2. Description of the Related Art

Internet Protocol Security, also referred to as IPSec or IPsec, is a framework for providing security in IP networks at network layer. IPSec is developed by The Internet Engineering Task Force (IETF). RFC documents (Request for Comments, RFC) 2401 to 2409 by IETF describe IPSec.

IPSec provides confidentiality services and authentication services to IP traffic. These services are provided by protocols called Authentication Header (AH, described in RFC 2402), which essentially allows authentication of the sender of data, and Encapsulating Security Payload (ESP, described in RFC 2406), which supports both authentication of the sender and encryption of data.

Authentication Header and Encapsulating Security Payload require session keys in order to operate. The session keys are typically generated via key management protocols, such as Internet Key Exchange (IKE, described in RFC 2409). A key management protocol called Authentication and Key Agreement (AKA) may also be used, particularly in communication networks based on 3GPP (3^{rd} Generation Partnership Project) systems. Additionally, there are other key management protocols that may be used.

In addition to the protocols mentioned above, IPSec uses security associations to provide its services. An IPSec security association comprises such information as traffic selectors, cryptographic transforms, session keys and session key lifetimes. A key management application is responsible for negotiating the creation and deletion of an IPSec security association.

Typically IPSec services and key management protocols may be found e.g. in dedicated security gateways, servers, desktop computers and handheld terminals. In prior art, whatever the target device, the IPSec services and key management protocols are tied together in the sense that they are co-located in the same device. So it also follows that the communication mechanism between IPSec services and an associated key management protocol is local.

In a distributed computing environment, however, network element functionality benefits from an architecture in which various applications are located in dedicated devices. For example, applications requiring cryptographic operations are typically located in a special purpose device containing suitable hardware and software for the task. Other applications may require more CPU processing power and may therefore be located in a different type of special purpose device. Further, in a distributed computing environment, applications typically require services from each other in order to provide the network element functionality.

In the case of network layer security, IPSec and its associated key management protocols are examples of applications requiring services from each other. It would be beneficial to arrange IPSec service on a device capable of high-speed symmetric cryptography, and to arrange its associated key management protocol in another device with high CPU power and/or asymmetric cryptography acceleration. Yet, as mentioned above, in prior art IPSec service and the key management protocol used by it are located in the same computing device. There are many key management protocols, each with different characteristics. If, as is the case with prior art, all these various key management protocols have to be located in the same device as the IPSec service, network element design, implementation and deployment become inefficient and sometimes even impossible.

Thus there is an obvious need for a more sophisticated approach allowing IPSec service and its associated key management protocols to be arranged on different devices, particularly in distributed computing environments. Further, it would be beneficial to be able to transparently do this distribution of IPSec and its associated key management.

### SUMMARY OF THE INVENTION

The present invention concerns a method and a system for remotely and transparently managing security associations of Internet Protocol Security.

The system comprises one or more application devices. Each application device comprises at least one management client for issuing security association management requests.

The system further comprises a service device. The service device comprises an Internet Protocol Security service means for providing one or more Internet Protocol Security services. The service device further comprises a management server for receiving the issued requests and for responding, in connection with the Internet Protocol Security service means, to the received requests.

The system further comprises a communication network for connecting the application devices to the service device.

In an embodiment of the invention at least one application device further comprises an interface means for providing an interface via which the at least one management client associated with the application device and the management server communicate with each other. Thus, the interface means according to the present invention and the management server according to the present invention allow such distribution of IPSec and its associated key management that is transparent to the management client and to the Internet Protocol Security service means. In other words, present management clients do not need to be modified for them to be able use services provided by the Internet Protocol Security service means even though said Internet Protocol Security service means may be located on another device than said management client.

In an embodiment of the invention the security association management requests include requests for adding security associations, requests for deleting security associations, and/or requests for querying about security associations.

In an embodiment of the invention the interface means includes data structures used in communication between the management client and the management server, and the interface means are implemented as a software library linked dynamically or statistically into a corresponding management client.

In an embodiment of the invention the interface means are arranged to use sockets for communication with the management server.

In an embodiment of the invention the Internet Protocol Security service means and the management server are arranged to use a local communication channel for communication with each other.

In an embodiment of the invention at least one application device comprises two or more management clients, at least two of which management clients utilize session key management protocols different from each other.

In an embodiment of the invention said communication network is a Local Area Network.

The invention makes it possible to remotely manage IPSec security associations. IPSec and its associated key management can be transparently distributed to separate computing devices. Thus each computing device can be optimized to run a specific application. This in turn increases performance and flexibility.

Yet, the invention does not preclude utilizing standard prior art solutions when beneficial. E.g. in smaller configurations the IPSec and its associated key management may still be co-located in the same device. This may be accomplished by switching a remote communication channel to a local one. The switch is transparent to the applications, thus minimizing development effort, and increasing flexibility.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram illustrating a system according to one embodiment of the invention; and

FIG. 2 illustrates a method according to one embodiment of the invention.

### DETAILED DESCRIPTION OF THE PREFERRED EMBODIMENTS

Reference will now be made in detail to the embodiments of the invention, examples of which are illustrated in the accompanying drawings.

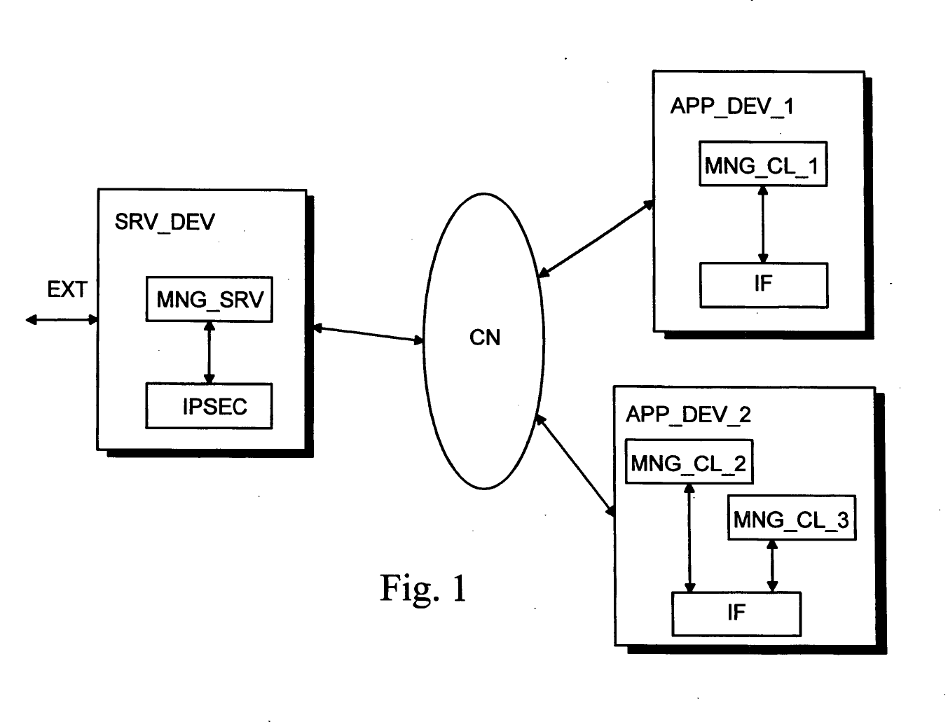

FIG. 1 illustrates a system for remotely and transparently managing security associations of Internet Protocol Security according to an embodiment of the invention. In the exemplary embodiment of the invention illustrated in FIG. 1 the system comprises two application devices APP_DEV_1 and APP_DEV_2. The application device APP_DEV_1 comprises one management client MNG_CL_1 for issuing security association management requests, whereas the application device APP_DEV_2 comprises two management clients MNG_CL_2 and MNG_CL_3. The security association management requests issued by management clients MNG_CL_1, MNG_CL_2 and MNG_CL_3 include requests for adding security associations, requests for deleting security associations, and/or requests for querying about security associations. In the exemplary embodiment of the invention illustrated in FIG. 1 the management clients MNG_CL_1, MNG_CL_2, MNG_CL_3 each utilize a different session key management protocol.

Internet Protocol Security is typically utilized for example by IP Multimedia Subsystem (IMS) of a 3GPP system based telecommunication network. In such a case, a user equipment (not illustrated) may communicate with the application device APP_DEV_1 or APP_DEV_2 by using a key management protocol, and the end result of this communication is then forwarded to the service device SRV_DEV by the application device APP_DEV_1 or APP_DEV_2. Thus, in this case, the application device APP_DEV_1 or APP_DEV_2 may be running a server portion of the key management protocol, whereas the user equipment may be running a client portion of the key management protocol. The user equipment may use its own local mechanism to communicate the end result to its own IPSec service.

In the exemplary embodiment of the invention illustrated in FIG. 1 the system further comprises a service device SRV_DEV. The service device SRV_DEV comprises an Internet Protocol Security service means IPSEC for providing one or more Internet Protocol Security services. The service device SRV_DEV further comprises a management server MNG_SRV for receiving the issued requests and for responding, in connection with the Internet Protocol Security service means IPSEC, to the received requests. The system further comprises a communication network CN for connecting the application devices to the service device.

In the exemplary embodiment of the invention illustrated in FIG. 1 the application devices APP_DEV_1 and APP_DEV_2 each further comprise an interface means IF for providing an interface via which the management clients MNG_CL_1, MNG_CL_2, MNG_CL_3 and the management server MNG_SRV communicate with each other. Further in the exemplary embodiment of the invention illustrated in FIG. 1 the interface means IF include data structures (not illustrated) used in communication between the management clients MNG_CL_1, MNG_CL_2, MNG_CL_3 and the management server MNG_SRV, and the interface means IF are each implemented as a software library (not illustrated) which may be linked either dynamically or statistically into a management client.

Further in the exemplary embodiment of the invention illustrated in FIG. 1 the interface means IF are each arranged to use sockets for communication with the management server MNG_SRV, and the Internet Protocol Security service means IPSEC and the management server MNG_SRV are arranged to use a local communication channel for communication with each other.

Further, as illustrated in FIG. 1, external IP traffic EXT entering the system is preferably routed via the service device SRV_DEV.

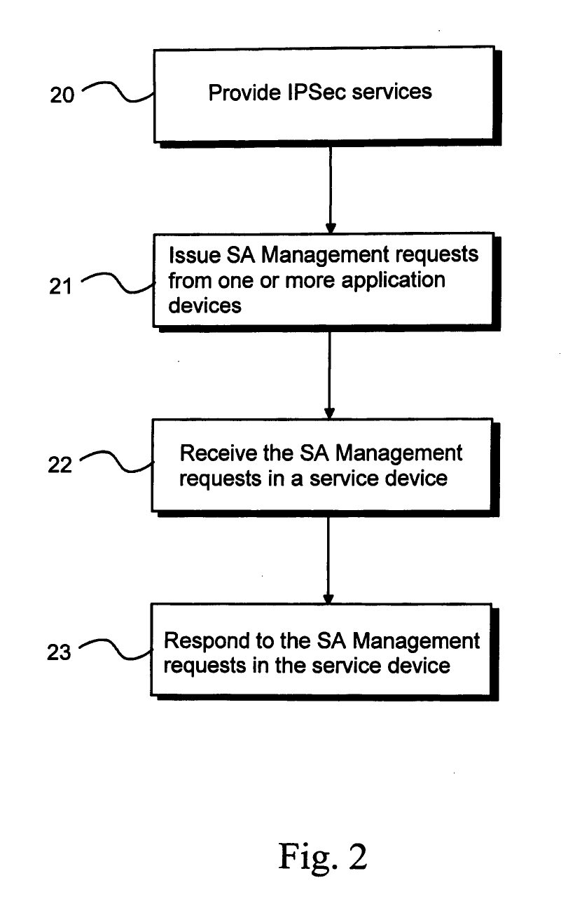

FIG. 2 illustrates a method for remotely and transparently managing security associations of Internet Protocol Security according to an embodiment of the invention.

One or more Internet Protocol Security services are provided in a service device, phase 20. Security association management requests are issued from one or more application devices, phase 21. The application devices have been securely connected to the service device by a communication network.

The issued requests are received in the service device, phase 22. The received requests are responded to in the service device in connection with the provided Internet Protocol Security services, phase 23.

In the exemplary embodiment of the invention illustrated in FIG. 2 the security association management requests issued from an application device, and/or corresponding responses are communicated via an interface associated with said application device.

It is obvious to a person skilled in the art that with the advancement of technology, the basic idea of the invention may be implemented in various ways. The invention and its embodiments are thus not limited to the examples described above, instead they may vary within the scope of the claims.

1. A system for remotely and transparently managing security associations of Internet Protocol Security, the system comprising:
an application device, said application device comprising at least one management client for issuing security association management requests;
a service device comprising an Internet Protocol Security service means for providing one or more Internet Protocol Security services, and a management server for receiving said security association management requests issued from said at least one management client and for responding, in connection with said Internet Protocol Security service means, to said security association management requests received at said management server; and
a communication network for connecting said application device to said service device.

2. The system according to claim 1, wherein said application device further comprises an interface means for providing an interface for communicating between said at least one management client associated with said application device and said management server.

3. The system according to claim 1, wherein said security association management requests include at least one of adding requests for adding security associations, deleting requests for deleting security associations, and querying requests for querying about security associations.

4. The system according to claim 2, wherein said interface means are arranged to use sockets for communication with said management server.

5. The system according to claim 2, wherein said interface means includes data structures used in communication between said management client and said management server.

6. The system according to claim 2, wherein said interface means are implemented as a software library linked dynamically or statistically into a corresponding management client.

7. The system according to claim 1, wherein said Internet Protocol Security service means and said management server are arranged to use a local communication channel for communications between said Internet Protocol Security service means and said management server.

8. The system according to claim 1, wherein at least one application device comprises two or more management clients, at least two of said management clients use different session key management protocols.

9. The system according to claim 1, wherein said communication network comprises a Local Area Network.

10. A method for remotely and transparently managing security associations of Internet Protocol Security, the method comprising the steps of:
providing one or more Internet Protocol Security services in a service device;
issuing security association management requests from an application device, said application device being connected to said service device by a communication network;
receiving in said service device said security association management requests issued from said application device; and
responding, in connection with an Internet Protocol Security service, to said security association management requests received in said service device.

11. The method according to claim 10, wherein at least one of said security association management requests issued from an application device and corresponding responses are communicated via an interface associated with said application device.

12. The method according to claim 10, wherein said security association management requests include at least one of adding requests for adding security associations, deleting requests for deleting security associations, and querying requests for querying about security associations.
